(19) United States
(12) Patent Application Publication
(10) Pub. No.: US 2012/0188858 A1
(43) Pub. Date: Jul. 26, 2012

(54) Wristwatch

(76) Inventor: Wai-Ho Eddie Leung, Kowloon (CN)

(21) Appl. No.: 13/036,229

(22) Filed: Feb. 28, 2011

(30) Foreign Application Priority Data
Jan. 24, 2011 (HK) 11100704.4

(51) Int. Cl. G04B 37/18

(52) U.S. Cl. 368/282; 368/281

(57) ABSTRACT

A wristwatch includes a moulded plastics case upper having first snap-engagement protrusions. A moulded plastics case lower has second snap-engagement protrusions cooperative with the first snap-engagement protrusions to secure the case upper and case lower together. The case upper and case lower can be of mutually different colour.

### BACKGROUND OF THE INVENTION

The present invention relates to wristwatches. The invention more particularly, although not exclusively, relates to a wristwatch and a wristband link which can be assembled easily from parts which might be of different coloured plastics material.

Wristwatches made of metallic or plastics casework comprise a body and a backing plate which are generally held together by engaging threads between the parts or with screws.

Assembly of such watches is time-consuming and expensive.

A wristwatch can be manufactured inexpensively and provide a certain aesthetic appeal resulting from its physical construction.

### SUMMARY

There is disclosed herein a wristwatch comprising:
a moulded plastics case upper having first snap-engagement protrusions;
a moulded plastics case lower having second snap-engagement protrusions cooperative with said first snap-engagement protrusions to secure the case upper and case lower together.

Preferably, the case upper and case lower are formed of plastics materials of mutually distinct surface colour, shade and/or texture.

Preferably, the case upper and case lower each have pin recesses which cooperate with one another to form a pin hole to capture a wristband pin when the case upper and case lower are mutually snap-engaged.

There is further disclosed herein a combination of the above-disclose wristwatch and a wristband, the wristband comprising a plurality of links in which each link comprises:
a moulded plastics link upper having first snap-engagement protrusions;
a moulded plastics link lower having second snap-engagement protrusions cooperative with said first snap-engagement protrusions to secure the link upper and link lower together.

Preferably, the link upper and link lower are formed of plastics materials of mutually distinct surface colour, shade and/or texture.

Preferably, the link upper and link lower each have pin recesses which cooperate with one another to form a pin hole to capture a wristband pin when the link upper and link lower are mutually snap-engaged.

### DEFINITION

As used herein, the word “protrusion” encompasses straight-edged features as illustrated in the drawings or any other interengaging features such as lips, barbs or studs and cooperating elements such as sockets, recesses and the like which are capable of snap-engagement by momentary elastic deformation of a least one of the mating components during assembly.

### BRIEF DESCRIPTION OF THE DRAWINGS

A preferred form of the present invention will now be described by way of example with reference to the accompanying drawings, wherein:

FIG. 1 is a schematic elevation of a wristwatch case;

FIG. 2 is a schematic cross-sectional parts-exploded elevation of the wristwatch case;

FIG. 3 is a schematic cross-sectional elevation of the wristwatch case;

FIG. 4 is a schematic plan illustration of a wristband link;

FIG. 5 is a schematic cross-sectional elevation taken at V-V of FIG. 4;

FIG. 6 is a schematic elevation of the wristband link;

FIG. 7 is a schematic parts-exploded cross-sectional elevation of the wristband link; and

FIG. 8 is a schematic cross-sectional elevation of the wristband link.

### DESCRIPTION OF THE PREFERRED EMBODIMENT

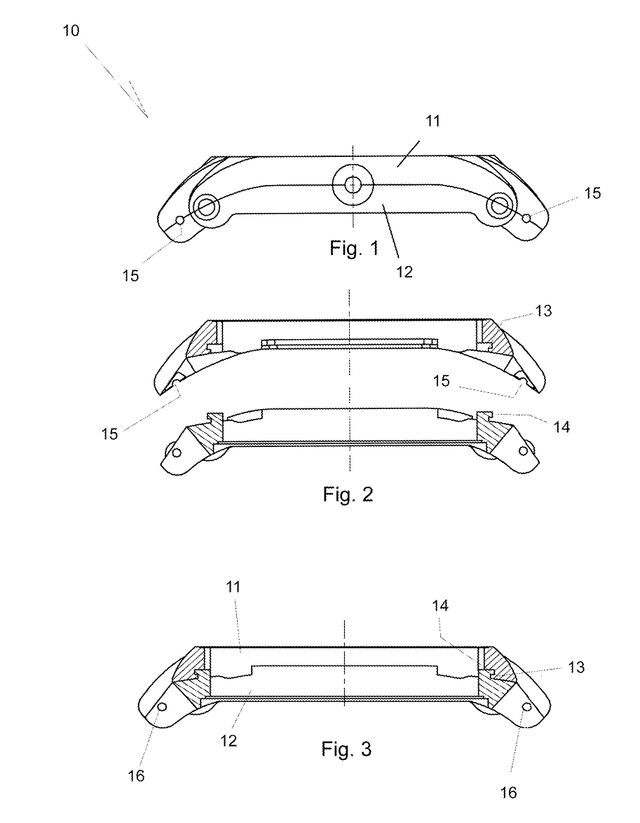

In FIGS. 1 to 3 of the accompanying drawings there is depicted schematically a wristwatch case 10. The case 10 comprises a moulded plastics case upper 11 and a moulded plastics case lower 12. These are typically formed of “PC” (polycarbonate) material. The case upper 11 and case lower 12 can be formed of different coloured plastics material and the construction embodied in the drawings lends itself to the manufacture of multi-coloured wristwatches in which the top portion is of one colour and the bottom portion is of another colour.

The case upper 11 includes snap-engagement protrusions 13 whereas the case lower 12 includes corresponding snap-engagement protrusions 14. The bottom surface of the case upper and the top surface of the case lower are of complementary profile so that when the two parts are mutually snap-engaged, they form a contiguous wristwatch case.

Both the case upper 11 and case lower 12 have semi-cylindrical pin recesses 15 which cooperate with one another to form a cylindrical pin recess as the case upper and case low are snapped together. A wristband pin is placed between the case upper and case lower prior to their mutual snap-engagement so that the pin is captured within the cylindrical formation formed between the parts by the aligned semi-cylindrical recesses.

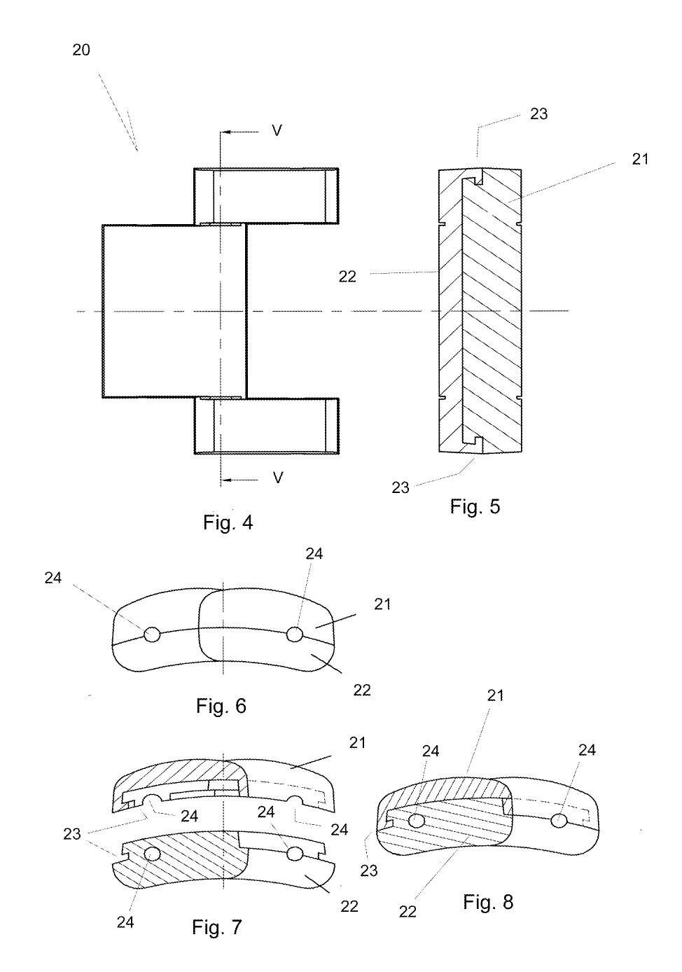

In FIGS. 4 to 8 of the coming drawings there is depicted a single link 20—a plurality of which would be articulated together to form a complementary wristband. The link comprises a link upper 21 and a link lower 22 again formed of moulded plastics material—typically PC (polycarbonate). Like the wristwatch case itself, the link upper 21 and link lower 22 can be of different coloured plastics material. These parts comprise mutually interengaging protrusions 23 which cooperate in the same manner as those described with reference to the wristwatch case. Similarly, each link comprises cooperating semi-cylindrical pin recesses 24 which together form a cylindrical pin recess as the link upper and link low are snapped together. A wristband pin is placed between the link upper and link lower prior to their mutual snap-engagement so that the pin is captured between the parts as the links are formed into a wristband.

It should be appreciated that modifications and alterations obvious to those skilled in the art are not to be considered as beyond the scope of the present invention. For example, where reference is made to parts of different colour, parts of different surface texture and/or shade are equally envisaged.

1. A wristwatch comprising:
a moulded plastics case upper having first snap-engagement protrusions;
a moulded plastics case lower having second snap-engagement protrusions cooperative with said first snap-engagement protrusions to secure the case upper and case lower together.

2. The wristwatch of claim 1, wherein the case upper and case lower are formed of plastics materials of mutually distinct surface colour, shade and/or texture.

3. The wristwatch of claim 1, wherein the case upper and case lower each have pin recesses which cooperate with one another to form a pin hole to capture a wristband pin when the case upper and case lower are mutually snap-engaged.

4. The wristwatch of claim 1 in combination with a wristband, the wristband comprising a plurality of links in which each link comprises:
a moulded plastics link upper having first snap-engagement protrusions;
a moulded plastics link lower having second snap-engagement protrusions cooperative with said first snap-engagement protrusions to secure the link upper and link lower together.

5. The wristwatch of claim 4, wherein the link upper and link lower are formed of plastics materials of mutually distinct surface colour, shade and/or texture.

6. The wristwatch of claim 4, wherein the link upper and link lower each have pin recesses which cooperate with one another to form a pin hole to capture a wristband pin when the link upper and link lower are mutually snap-engaged.
